(19) United States
(12) Patent Application Publication
(10) Pub. No.: US 2015/0363574 A1
(43) Pub. Date: Dec. 17, 2015

(54) EMERGENCY MEDICAL SERVICE SYSTEM, EMERGENCY RESPONSE APPARATUS, AND EMERGENCY MEDICAL INFORMATION PROVIDING APPARATUS

(71) Applicant: ALLM INC., Tokyo (JP)

(72) Inventors: Hiroyuki TAKAO, Tokyo (JP); Yuichi MURAYAMA, Tokyo (JP); Teppei SAKANO, Tokyo (JP)

(73) Assignee: ALLM INC., Tokyo (JP)

(21) Appl. No.: 14/764,880

(22) PCT Filed: Sep. 3, 2014
(86) PCT No.: PCT/JP2014/073181

§ 371 Date: Jul. 30, 2015

(30) Foreign Application Priority Data
Sep. 18, 2013 (JP) 2013-192559

(51) Int. Cl. G06F 19/00

(52) U.S. Cl. CPC G06F 19/3481

(57) ABSTRACT

Treatment contents to be given to a user are notified to an operating person of an emergency response apparatus. An emergency medical service system 100 includes an emergency response apparatus 200 operated by an operating person to give first aid to a user when the user needs the first aid and an emergency medical information providing apparatus 300 connected to the emergency response apparatus through a communication line. The emergency response apparatus 200 receives treatment contents information from the emergency medical information providing apparatus 300 and notifies, to the operating person, treatment contents specified based on the treatment contents information.

### TECHNICAL FIELD

The present invention relates to an emergency medical service system, an emergency response apparatus, and an emergency medical information providing apparatus.

### BACKGROUND ART

The following care/nursing system has been known. In the care/nursing system, a person to be cared, who encounters an emergent situation such as an accident or sudden illness at an outing destination or in motion transmit a report to a system operator side by using own mobile information terminal device. Here, by reporting identification information thereof to the system operator side and by telling the encountered emergent situation or a detail situation of the self to an operator on the system operator side, the person to be cared asks for a more suitable care/nursing service. In a computer apparatus on the system operator side, comprehensive determination is made with respect to the reported identification information of the person to be cared, the detail information related to the emergent situation told by the person to be cared, and individual information related to a physical condition of the person to be cared and contents or a degree of a care/nursing service to be provided is determined (see Patent Literature 1).

### CITATION LIST

### Patent Literature

Patent Literature 1: JP 2005-173854 A

### SUMMARY OF INVENTION

### Technical Problem

In a conventional care/nursing system, a computer apparatus on a system operator side determines contents or a degree of a care/nursing service to be provided based on detail information related to an emergent situation told by the person to be cared and individual information related to a physical condition of the person to be cared. Thus, the person to be cared needs to be able to communicate with an operator or the like on a system operator side. Thus, in a case of using the conventional care/nursing system for an emergency response of a user, when the user is not able to tell own situation and needs first aid, it may not be possible to determine contents of first aid to be given to the user and to give proper first aid to a user.

### Solution to Problem

According to a first aspect of the present invention, an emergency medical service system includes: an emergency response apparatus operated by an operating person to give first aid to a user when the user needs the first aid; and an emergency medical information providing apparatus connected to the emergency response apparatus through a communication line, and the emergency response apparatus includes a user specification information transmission unit configured to transmit information for specification of the user to the emergency medical information providing apparatus, a treatment contents information reception unit configured to receive, from the emergency medical information providing apparatus, treatment contents information indicating treatment contents given to the user, and a treatment contents notification unit configured to notify, to the operating person, the treatment contents specified based on the treatment contents information received by the treatment contents information reception unit, the emergency medical information providing apparatus includes a user specification information reception unit configured to receive the information for specification of the user from the emergency response apparatus, a user information reading unit configured to read, from a recording device, user information associated with the information for specification of the user received by the user specification information reception unit, a unit of specifying a name of a medicine configured to specify a name of a medicine taken by the user based on dosing information indicating information related to the medicine, which is taken by the user, in a case where the dosing information is included in the user information read by the user information reading unit, a dosing information determination unit configured to determine, with reference to treatment contents specification information which includes a name of a medicine and treatment contents information indicating treatment contents determined by the name of a medicine and which is recorded in the recording device, whether treatment contents specification information including the name of a medicine specified by the unit of specifying a name of a medicine is recorded in the treatment contents specification information, a unit of specifying a name of a disease configured to specify a name of a disease the user has based on clinical history information indicating a clinical history of the user in a case where the clinical history information is included in the user information read by the user information reading unit, a clinical history information determination unit configured to determine, with reference to treatment contents specification information which includes a name of a disease and treatment contents information indicating treatment contents determined by the name of a disease and which is recorded in the recording device, whether treatment contents specification information including the name of a disease specified by the unit of specifying a name of a disease is recorded in the treatment contents specification information, a treatment contents information specification unit configured to specify treatment contents information for transmission which information is to be transmitted to the emergency response apparatus based only on a result of the determination by the dosing information determination unit and a result of the determination by the clinical history information determination unit, and a treatment contents information transmission unit configured to transmit, to the emergency response apparatus, the treatment contents information for transmission, which is specified by the treatment contents information specification unit, as treatment contents information indicating treatment contents given to the user, and when it is determined by the dosing information determination unit that the treatment contents specification information including the name of a medicine specified by the unit of specifying a name of a medicine is recorded, the treatment contents information specification unit specifies, as the treatment contents information for transmission, treatment contents information included in the treatment contents specification information and when it is determined by the clinical history information determination unit that the treatment contents specification information including the name of a disease specified by the unit of specifying a name of a disease is recorded, the treatment contents information specification unit specifies, as the treatment contents information for transmission, treatment contents information included in the treatment contents specification information.

According to a second aspect of the present invention, in the emergency medical service system according to the first aspect, the user information includes user attribute information indicating an attribute of the user, the dosing information, the clinical history information, and emergency transfer destination information indicating an emergency transfer destination of the user, the emergency medical information providing apparatus further includes a user information transmission unit configured to transmit the user information read by the user information reading unit to the emergency response apparatus, and the emergency response apparatus further includes a user information reception unit configured to receive the user information from the emergency medical information providing apparatus, and a user information notification unit configured to notify the user information received by the user information reception unit to the operating person.

According to a third aspect of the present invention, in the emergency medical service system according to the second aspect, the emergency response apparatus further includes an emergent state specification unit configured to specify an emergent state of the user based on operation performed by the operating person, and a prior notification determination unit configured to determine which of a notification of the user information by the user information notification unit and a notification of the treatment contents by the treatment contents notification unit is to be given preferentially based on the emergent state of the user specified by the emergent state specification unit.

According to a fourth aspect of the present invention, in the emergency medical service system according to the third aspect, the prior notification determination unit is configured to determine whether there are a response of the user to a call from the operating person and breathing of the user based on the emergent state of the user specified by the emergent state specification unit, when it is determined that at least one of the response of the user and the breathing of the user is not performed, it is determined that the notification of the user information by the user information notification unit is given prior to the notification of the treatment contents by the treatment contents notification unit, and when it is determined that there are both of the response of the user and the breathing of the user, it is determined that the notification of the treatment contents by the treatment contents notification unit is given prior to the notification of the user information by the user information notification unit.

According to a fifth aspect of the present invention, in the emergency medical service system according to the fourth aspect, when determining that at least one of the response of the user and the breathing of the user is not performed based on the emergent state of the user specified by the emergent state specification unit, the user information notification unit preferentially notifies the emergency transfer destination information in the user information.

According to a sixth aspect of the present invention, in the emergency medical service system according to the fourth or fifth aspect, the emergency response apparatus further includes a breast bone pressing method notification unit configured to notify, to the operating person, a method of breast bone pressing performed with respect to the user when it is determined that at least one of the response of the user and the breathing of the user is not performed based on the emergent state of the user specified by the emergent state specification unit.

According to a seventh aspect of the present invention, in the emergency medical service system according to the sixth aspect, the emergency response apparatus further includes an artificial respiration method notification unit to notify, to the operating person, a method of artificial respiration performed with respect to the user along with the method of breast bone pressing when it is determined that at least one of the response of the user and the breathing of the user is not performed based on the emergent state of the user specified by the emergent state specification unit and when it is determined that the artificial respiration is necessary for the user.

According to an eighth aspect of the present invention, in the emergency medical service system according to the seventh aspect, the artificial respiration method notification unit determines that the artificial respiration is necessary for the user when the user is a child.

According to a ninth aspect of the present invention, in the emergency medical service system according to any of the second to eighth aspects, the emergency response apparatus further includes a unit of receiving an input of a release code configured to receive, from the operating person, an input of a release code to release browsing restriction of the user information, and a release code transmission unit configured to transmit the release code, an input of which is received by the unit of receiving an input of a release code, to the emergency medical information providing apparatus, and the emergency medical information providing apparatus further includes a release code reception unit configured to receive the release code from the emergency response apparatus, an authentication unit configured to perform authentication whether the release code received by the release code reception unit is a valid release code, and a user information editing unit configured to perform editing for restriction of browsing, by the operating person, of at least a previously-set part of the user information specified by the user information specification unit when it is determined by the authentication unit that the release code is not the valid release code.

According to a tenth aspect of the present invention, in the emergency medical service system according to any of the second to ninth aspects, in a case of displaying the emergency transfer destination information included in the user information, the user information notification unit displays, on a display device, a call button to receive an instruction for calling an emergency transfer destination from the operating person.

According to an eleventh aspect of the present invention, in the emergency medical service system according to the tenth aspect, the emergency response apparatus further includes a calling unit configured to specify a telephone number of a hospital specified as the emergency transfer destination based on the emergency transfer destination information and to make a call to the telephone number when operation on the call button performed by the operating person is detected.

According to a twelfth aspect of the present invention, in the emergency medical service system according to any of the first to eleventh aspects, the emergency response apparatus further includes an accidental ingestion determination unit to determine whether the user accidentally ingests a foreign object, and a unit of notifying a method of removing a foreign object configured to notify a method of removing a foreign object to the operating person when it is determined by the accidental ingestion determination unit that the user accidentally ingests the foreign object.

According to a thirteenth aspect of the present invention, an emergency response apparatus is used in the emergency medical service system.

According to a fourteenth aspect of the present invention, an emergency medical information providing apparatus is used in the emergency medical service system.

### Advantageous Effects of Invention

According to the present invention, treatment contents information indicating treatment contents to be given to a user is specified with reference to treatment contents specification information to specify treatment contents for each symptom and the specified treatment contents are notified to an operating person. Thus, even when the user is not able to communicate, it is possible for the operating person to understand the treatment contents and to give first aid to the user.

### BRIEF DESCRIPTION OF DRAWINGS

FIG. 1 is a block diagram illustrating a configuration of an embodiment of an emergency medical service system 100.

FIG. 2 is a block diagram illustrating a configuration of an embodiment of an emergency response apparatus 200.

FIG. 3 is a block diagram illustrating a configuration of an embodiment of an emergency medical information providing apparatus 300.

FIG. 4 is a flowchart illustrating a flow of processing executed in an emergency response apparatus 200 in a first embodiment.

FIG. 5 is a flowchart illustrating a flow of processing executed in the emergency medical information providing apparatus 300.

FIG. 6 is a flowchart illustrating a flow of processing executed in an emergency response apparatus 200 in a second embodiment.

### DESCRIPTION OF EMBODIMENTS

### First Embodiment

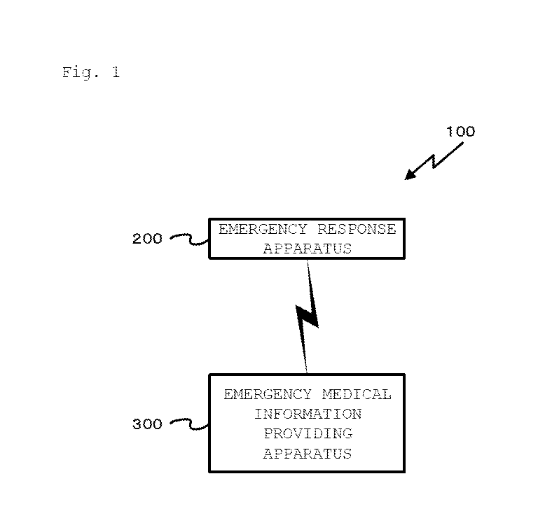

FIG. 1 is a block diagram illustrating a configuration of an embodiment of an emergency medical service system in the present embodiment. An emergency medical service system 100 includes an emergency response apparatus 200 and an emergency medical information providing apparatus 300. The emergency response apparatus 200 is a terminal owned by a user and is, for example, an information terminal such as a smartphone or a tablet terminal. Also, the emergency medical information providing apparatus 300 is an apparatus to communicate with the emergency response apparatus 200 and to execute various kinds of processing and is, for example, an information processing apparatus such as a server apparatus or a personal computer.

In the present embodiment, the emergency response apparatus 200 and the emergency medical information providing apparatus 300 are connected to each other through a communication line such as the Internet or the mobile telephone network. Note that in FIG. 1, an example in which the emergency medical service system 100 includes one emergency response apparatus 200 and one emergency medical information providing apparatus 300 is illustrated. However, a configuration of the emergency medical service system 100 is not limited to the example. For example, processing may be distributed in a plurality of emergency medical information providing apparatuses 300. Also, the number of emergency response apparatuses 200 is not particularly limited.

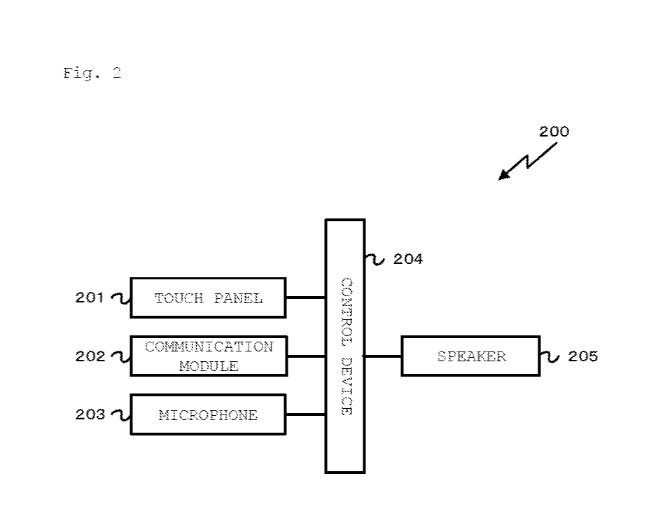

FIG. 2 is a block diagram illustrating a configuration of an embodiment in a case where a smartphone is used as the emergency response apparatus 200 in the present embodiment. In the present embodiment, communication with the emergency medical information providing apparatus 300 is performed and an emergency medical service application to provide various functions described in the following is installed into the smartphone, whereby the smartphone operates as the emergency response apparatus 200 in the present embodiment. Note that a program of the emergency medical service application is provided by being published on a server connected through the Internet. The program is downloaded and acquired by the user and is previously installed in the emergency response apparatus 200. Alternatively, the program of the emergency medical service application may be provided by being recorded in a recording medium such as a CD-ROM or a DVD-ROM.

The emergency response apparatus 200 includes a touch panel 201, a communication module 202, a microphone 203, a control device 204, and a speaker 205.

The touch panel 201 is an electronic component which is a combination of a display device such as a liquid crystal panel and a position input device such as a touch pad and which is an input device in which a device can be operated by pushing a display on a screen. For example, a user of the emergency response apparatus 200 can operate the emergency response apparatus 200 by touching or sliding a display item such as a button or a menu displayed on a liquid crystal panel by using a finger or a stylus. The touch panel 201 detects the operation such as a touch or slide performed by the user and outputs a detection signal to the control device 204.

As the communication module 202, a module to be connected with the Internet wirelessly or by wire through a LAN or a mobile phone communication network is used. The emergency response apparatus 200 communicates with the emergency medical information providing apparatus 300 through the communication module 202.

The microphone 203 is a sound collection device to input an utterance sound of the user. Analog data input from the microphone 203 is converted into a digital signal by the control device 204.

The control device 204 includes a CPU, a memory, and a different peripheral circuit and controls the emergency response apparatus 200 as a whole. Note that the memory included in the control device 204 includes, for example, a volatile memory such as an SDRAM or a non-volatile memory such as a flash memory. The volatile memory is used as a work memory in which the CPU expands a program during execution of the program or as a buffer memory to temporarily record data. Also, in the non-volatile memory, firmware to operate the emergency response apparatus 200 or program data of software to operate various applications is recorded. In the present embodiment, the program of the above-described emergency medical service application is recorded in the non-volatile memory.

The speaker 205 is an output device to output sound. The control device 204 outputs, through the speaker 205, sound data of when there is a call from a different user or sound data recorded in the non-volatile memory.

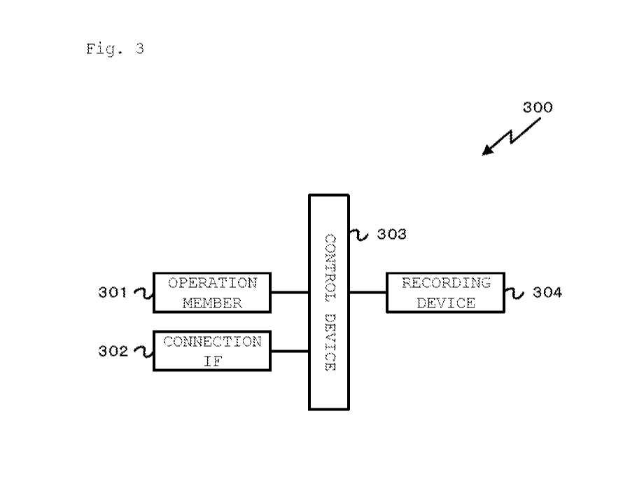

FIG. 3 is a block diagram illustrating a configuration of an embodiment in a case where a server apparatus is used as the emergency medical information providing apparatus 300 in the present embodiment. The emergency medical information providing apparatus 300 includes an operation member 301, a connection interface (IF) 302, a control device 303, and a recording device 304.

The operation member 301 includes various devices, such as a keyboard or a mouse, operated by an operating person of the emergency medical information providing apparatus 300.

The connection IF 302 is an interface to connect the emergency medical information providing apparatus 300 to a communication line such as the Internet. As the connection IF 302, for example, a wired LAN module for wired connection with the Internet or a wireless LAN module for wireless connection with the Internet is used.

The control device 303 includes a CPU, a memory, and a different peripheral circuit and controls the emergency medical information providing apparatus 300 as a whole. Note that the memory included in the control device 303 is, for example, a volatile memory such as an SDRAM. The memory is used as a work memory in which the CPU expands a program during execution of the program or as a buffer memory to temporarily store data. For example, data read through the connection IF 302 is temporarily stored in the buffer memory.

The recording device 304 is a recording device to record various kinds of data accumulated in the emergency medical information providing apparatus 300, data of a program to be executed by the control device 303, or the like. As the recording device 304, for example, a hard disk drive (HDD) or a solid state drive (SSD) is used. Note that the data of the program recorded in the recording device 304 is provided by being recorded in a recording medium such as a CD-ROM or a DVD-ROM or is provided through a network. When a user acquires the data of the program and installs the data into the recording device 304, the control device 303 can execute the program.

In the emergency medical service system 100 in the present embodiment, when a user who owns the emergency response apparatus 200 needs first aid, a person who gives the first aid to the user can operate the emergency response apparatus 200 and can acquire contents of the first aid to be given to the user, information of a hospital to which the user is transferred, or the like. As an operating person of the emergency response apparatus 200, for example, a person who happens to be in the place where the user needs the first aid or an ambulance attendant rushes to the place in response to a call is considered.

Conventionally, in a site of emergency, as first aid before an arrival of an ambulance and during a transfer to a hospital, a uniformed treatment is generally given to a patient. However, when a proper treatment corresponding to a situation of a patient is given instead of the uniformed treatment, a result preferable to the patient becomes more likely. On the other hand, there are not many people who regularly carry what shows a situation of an emergency patient such as a medicine pocketbook or a health insurance card. This has been an obstacle of a treatment corresponding to a situation of the emergency patient. Thus, in the present embodiment, a method to use a mobile terminal such as a smartphone which is likely to be carried by a user as the emergency response apparatus 200 and to make it possible for an operating person to properly respond to an emergency of the user by processing described in the following will be described.

In the recording device 304 of the emergency medical information providing apparatus 300, treatment contents specification information to specify contents of first aid corresponding to a symptom of an emergency patient is previously recorded. As the treatment contents specification information, a name of first aid, text data for describing contents of first aid, image data for describing contents of first aid, a keyword of dosing, and a keyword of a clinical history are included. Note that in the present embodiment, the name of first aid, the text data for describing contents of first aid, and the image data for describing contents of first aid included in the treatment contents specification information are referred to as treatment contents information.

As the name of first aid, a general name of first aid is recorded. As the text data for describing contents of first aid, text data for describing contents or a method of first aid to the operating person is recorded. As the image data for describing contents of first aid, image data for describing contents or a method of first aid to the operating person is recorded. As the keyword of dosing, a name of a medicine which is likely to be taken by a patient who may encounter a symptom to which first aid is necessary is recorded as a keyword. In a case where there is a plurality of medicines to be objects, names of the plurality of medicines are recorded. As the keyword of clinical history, a name of a disease which may cause development of a symptom to which first aid is necessary is recorded as a keyword. In a case where there is a plurality of names of diseases to be objects, the plurality of names of diseases is recorded.

In the emergency response apparatus 200, when execution of the above-described emergency medical service application is instructed by a touch by a user on an icon displayed on the touch panel 201, the control device 204 activates the emergency medical service application.

After the emergency medical service application is activated, the user performs operation on a screen displayed on the touch panel 201 and inputs user information, which is related to the user, as information necessary for notification of proper treatment contents to an operating person in a case where the user himself/herself needs first aid. In the present embodiment, as the user information, for example, user attribute information indicating an attribute of the user, dosing information indicating information related to a medicine taken by the user, clinical history information indicating a clinical history of the user, and emergency transfer destination information indicating an emergency transfer destination of the user are included.

As the user attribute information, information such as a mane, a birth date, a blood type, a height, or a weight of a user is input. When there is a medicine taken by a user, a name of the medicine (hereinafter, referred to as “name of medicine”) is input as the dosing information. Note that in a case where there is a plurality of medicines taken by a user, the names of the plurality of medicines are input. As the clinical history information, a name of a disease which a user currently has or the user used to have (hereinafter, referred to as “name of a disease”) is input. In a case where a user regularly goes to a hospital, the hospital where the user regularly goes, a name of an attending doctor in the hospital where the user regularly goes, and a telephone number of the hospital where the user regularly goes are input as the emergency transfer destination information. Note that when there is a plurality of hospitals where the user regularly goes, information related to the plurality of hospitals is input and any one of the hospitals is specified as a prior transfer destination in emergency.

When the user ends an input of the user information, the control device 204 transmits the input user information to the emergency medical information providing apparatus 300 through the communication module 202.

In the emergency medical information providing apparatus 300, when receiving the user information from the emergency response apparatus 200, the control device 303 issues a user ID to the user. The user ID has a predetermined number of digits and is used to uniquely identify the user. Then, the control device 303 associates the issued user ID and the user information with each other and records the associated user ID and user information into the recording device 304. Also, the control device 303 transmits the issued user ID to the emergency response apparatus 200. In the emergency response apparatus 200, when receiving the user ID from the emergency medical information providing apparatus 300, the control device 204 records the received user ID into the memory and notifies the user ID to the user.

After usage of the emergency medical service application is started, the user can correct, at arbitrary timing, registered contents of the user attribute information, the dosing information, the clinical history information, and the emergency transfer destination information included in the user information. When any piece of the information included in the user information is corrected by the user, the control device 204 transmits the user ID recorded in the memory and the corrected user information to the emergency medical information providing apparatus 300.

In the emergency medical information providing apparatus 300, when receiving the user ID and the corrected user information from the emergency response apparatus 200, the control device 303 performs updating by rewriting recorded user information, which is associated with the received user ID, to the corrected contents received thereby. Accordingly, user information is constantly kept updated.

When first aid becomes necessary to the user, for example, in a case where the user who owns the emergency response apparatus 200 feels sick or faints at an outing destination, a person who happens to be in the place, an ambulance attendant who rushes to the place in response to a call, or the like becomes an operating person of the emergency response apparatus 200. The operating person understands contents of a treatment suitable for the user by operating the emergency response apparatus 200 owned by the user. Accordingly, the operating person can give a treatment, which is suitable for the user, to the user who needs the first aid. In the following, a method with which the operating person understands the contents of the treatment suitable for the user by using the emergency response apparatus 200 will be described.

Generally, in a smartphone used as the emergency response apparatus 200, the terminal is often locked in order to prevent operation by a third person without permission. In this case, the user of the emergency response apparatus 200 is the only one who can release the lock of the terminal. However, when the user is in need for the first aid, it is difficult for the user to release the lock of the emergency response apparatus 200. Thus, in the present embodiment, even in the case where the emergency response apparatus 200 is locked, execution of the emergency medical service application is allowed. Accordingly, even when the user is not able to release the lock of the emergency response apparatus 200, the operating person can execute the emergency medical service application.

As described above, as the operating person, various people such as a common person who happens to be in the place and medical personnel such as an ambulance attendant who rushes to the place in response to a call are considered. Thus, there is a person to whom personal information of the user should be shown and a person to whom the personal information of the user should not be shown in the operating person. Thus, in the present embodiment, there is browsing restriction of the user information recorded in the emergency medical information providing apparatus 300. With respect to a request from the emergency response apparatus 200, the control device 303 allows only the user authenticated by the above-described user ID and an operating person, who correctly input a release code to release the browsing restriction of the user information, to browse the user information. Note that the release code is previously notified to an operating person, such as an ambulance attendant, who is required to understand the user information and to perform proper treatment. The notified release code is recorded in the recording device 304 of the emergency medical information providing apparatus 300.

When the emergency medical service application is activated while the lock of the emergency response apparatus 200 is released, the control device 204 determines that execution of the emergency medical service application is instructed by the user. In this case, the user can register, correct, and browse the user information. On the other hand, when the emergency medical service application is activated while the emergency response apparatus 200 is locked, the control device 204 determines that execution of the emergency medical service application is instructed by the operating person.

When the emergency medical service application is activated by the instruction of execution of the emergency medical service application given by the operating person, the control device 204 displays, on the touch panel 201, a release code input screen to prompt an input of the release code.

The operating person to whom the release code is previously issued inputs the release code on the release code input screen and performs operation for ending the input. As the operation for ending the input, for example, a touch on an end button displayed on the release code input screen is considered. On the other hand, the operating person to whom the release code is not issued performs the operation for ending the input without inputting the release code on the release code input screen. The control device 204 records, as operating person determination information, the release code input on the release code input screen or information, which indicates that the release code is not input, into the memory.

When the operation for ending the input is performed by the operating person, the control device 204 displays an emergent state checking screen to check an emergent state of the user on the touch panel 201. On the emergent state checking screen, a question to check a current state of the user is displayed for the operating person and the operating person answers the question according to a state of the user.

In the present embodiment, the control device 204 displays, on the emergent state checking screen, a question such as “Is there a response?” as the question to check whether the user responds to a call from the operating person. Also, buttons of “Yes” and “No” with which the operating person responds to the question are displayed on the emergent state checking screen. By detecting touch operation on the “Yes” button or the “No” button performed by the operating person, the control device 204 specifies whether there is a response of the user and records information indicating the specified result into the memory.

Also, the control device 204 displays, on the emergent state checking screen, a question such as “Is he/she breathing?” as a question to check whether the user is breathing. Also, buttons of “Yes” and “No” with which the operating person responds to the question are displayed on the emergent state checking screen. By detecting touch operation on the “Yes” button or the “No” button performed by the operating person, the control device 204 specifies whether the user is breathing and records information indicating the specified result into the memory.

The control device 204 transmits the user ID of the user and the operating person determination information which are recorded in the memory to the emergency medical information providing apparatus 300.

In the emergency medical information providing apparatus 300, when receiving the user ID and the operating person determination information from the emergency response apparatus 200, the control device 303 first determines whether there is what matches the release code, which is received as the operating person determination information, in the release code recorded in the recording device 304. Accordingly, the control device 303 performs authentication whether the received release code is a valid release code. As a result, when it is determined that there is what matches the release code, which is received as the operating person determination information, in the release code recorded in the recording device 304, it is determined that the operating person operating the emergency response apparatus 200 is a person allowed to browse the user information. On the other hand, when there is not what matches the release code, which is received as the operating person determination information, in the release code recorded in the recording device 304 or when information indicating that the release code is not input is received as the operating person determination information, the control device 303 determines that the operating person operating the emergency response apparatus 200 is a person not allowed to browse the user information.

Based on the user ID received from the emergency response apparatus 200, the control device 303 reads, from the recording device 304, the user attribute information, the dosing information, the clinical history information, and the emergency transfer destination information of the user.

Based on the read dosing information of the user, the control device 303 specifies a medicine taken by the user. The control device 303 refers to treatment contents specification information recorded in the recording device 304 and determines whether treatment contents specification information including, as a keyword of dosing, a name of a taken medicine which name is specified based on the dosing information of the user is recorded in the treatment contents specification information. As a result, when it is determined that the treatment contents specification information including, as the keyword of dosing, the name of a medicine taken by the user is recorded in the treatment contents specification information, processing contents information included in the treatment contents specification information is read from the recording device 304.

Also, based on the read clinical history information of the user, the control device 303 specifies a clinical history of the user. The control device 303 refers to the treatment contents specification information recorded in the recording device 304 and determines whether treatment contents specification information including, as a keyword of a clinical history, a name of a disease which the user used to have and which is specified based on the clinical history information of the user is recorded in the treatment contents specification information. As a result, when it is determined that treatment contents specification information, in which the treatment contents specification information including, as the keyword of a clinical history, the name of a disease the user used to have is recorded, is recorded in the treatment contents specification information, processing contents information included in the treatment contents specification information is read from the recording device 304.

The control device 303 transmits, as information for transmission, the user attribute information, the dosing information, the clinical history information, the emergency transfer destination information, and the treatment contents information which are read from the recording device 304 to the emergency response apparatus 200. Here, when it is determined based on the release code in the above-described processing that the operating person operating the emergency response apparatus 200 is a person not allowed to browse the user information, the control device 303 performs processing to restrict browsing of information to be restricted, which information corresponds to personal information of the user and seems not necessary for first aid given by a common person, in the information for transmission and updates the information for transmission. Then, the control device 303 transmits, to the emergency response apparatus 200, the information for transmission on which processing to limit the browsing is performed.

Note that which information in the information for transmission is set as the information to be restricted is previously set. For example, a birth date, a height, and a weight included in the user attribute information, the dosing information, and the clinical history information are set as the information to be restricted. Also, as the processing to restrict the browsing of the information to be restricted, editing such as replacing the information to be restricted with a null character, deleting the information to be restricted, or blacking out the information to be restricted is performed.

In the emergency response apparatus 200, the control device 204 displays, on the touch panel 201, the information for transmission received from the emergency medical information providing apparatus 300 and gives notification to the operating person. Here, based on the emergent state of the user, the control device 204 changes an order of displaying each piece of information included in the information for transmission.

More specifically, the control device 204 reads, from the memory, information indicating the specified result of the emergent state of the user which is based on the above-described operation on the emergent state checking screen and determines, based on the information, whether there is a response of the user to a call from the operating person and whether the user is breathing. As a result, when determining that at least one of the response of the user or the breathing of the user is not performed, the control device 204 preferentially displays the emergency transfer destination information included in the information for transmission. For example, the control device 204 transitions the screen in the following manner. First, the control device 204 displays, on the touch panel 201, an emergency transfer destination information display screen which displays the emergency transfer destination information. Then, when operation for switching to a next screen is performed by the operating person, the control device 204 displays a treatment contents display screen which displays the treatment contents information. When the operation for switching to a next screen is further performed by the operating person, the control device 204 displays a user-related information display screen which displays the user attribute information, the dosing information, and the clinical history information.

On the other hand, when determining that there are both of the response of the user and the breathing of the user, the control device 204 preferentially displays treatment contents information included in the information for transmission. For example, the control device 204 transitions the screen in the following manner. First, the control device 204 displays, on the touch panel 201, the treatment contents information display screen which displays the treatment contents information. Then, when operation for switching to a next screen is performed by the operating person, the control device 204 displays the user-related information display screen which displays the user attribute information, the dosing information, and the clinical history information. When the operation for switching to a next screen is further performed by the operating person, the control device 204 displays the emergency transfer destination information display screen which displays the emergency transfer destination information.

Accordingly, in a situation in which a transfer to an emergency transfer destination is preferentially performed, such as in a case where there is no response of the user or when the user is not breathing, the emergency transfer destination information is preferentially displayed, whereby the emergency transfer destination can be preferentially notified to the operating person. Also, in a situation in which first aid at the place is preferably given prior to the transfer to the emergency transfer destination, such as in a case where there is a response of the user and the user is breathing, the treatment contents information is preferentially displayed. Thus, treatment contents to be given to the user can be preferentially notified to the operating person.

Also, in the present embodiment, in a case of notifying the emergency transfer destination information to the operating person, the control device 204 displays, on the emergency transfer destination information display screen displayed on the touch panel 201, a call button to receive an instruction for calling the emergency transfer destination from the operating person. When detecting that the call button is touched by the operating person, the control device 204 specifies a telephone number of a hospital of the emergency transfer destination based on the emergency transfer destination information. Then, the control device 204 activates a call function included in the emergency response apparatus 200 and makes a call with the specified telephone number as a destination. Accordingly, the operating person can make a call to the hospital of the emergency transfer destination with easy operation without inputting the telephone number. Also, even when the user is in the emergent state and the operating person is in panic, it is possible to prevent an error in inputting the telephone number and to securely make a call to the hospital of the emergency transfer destination.

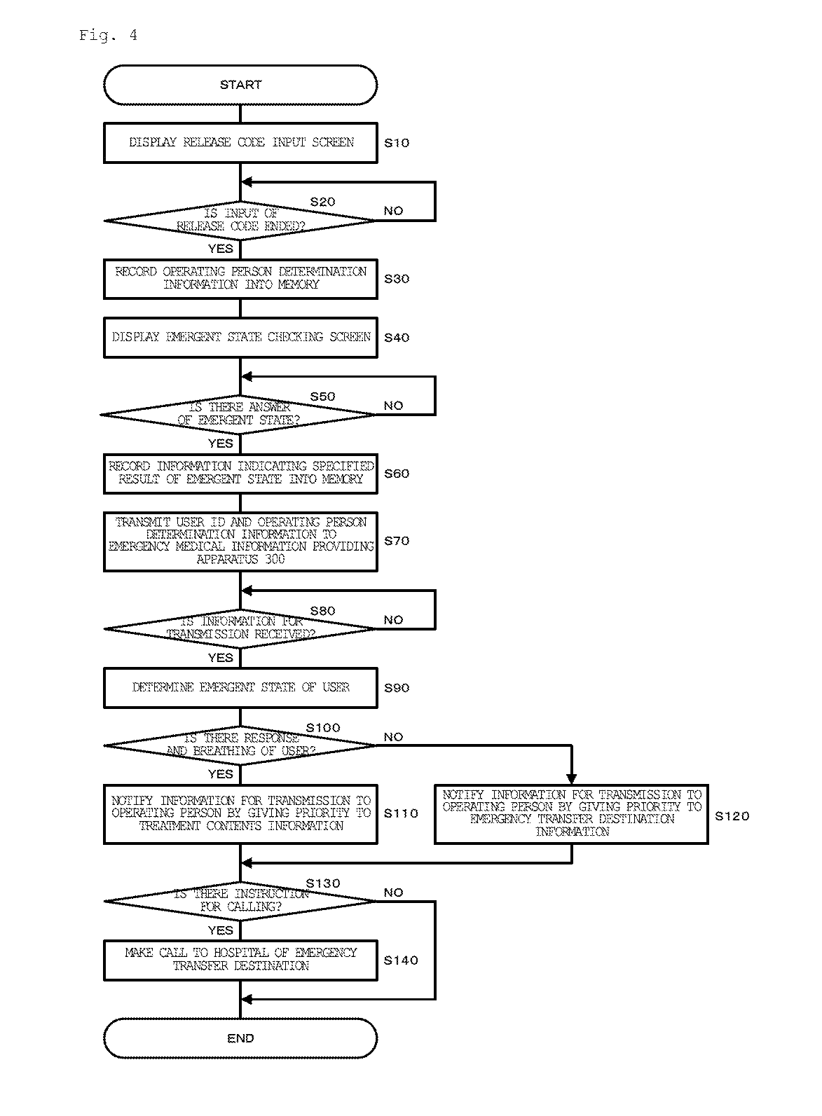

FIG. 4 is a flowchart illustrating a flow of processing executed by the emergency response apparatus 200 in the present embodiment. As described above, the processing illustrated in FIG. 4 is executed by the control device 204 as program activated when the emergency medical service application is instructed by the operating person while the emergency response apparatus 200 is locked.

In step S10, the control device 204 displays, on the touch panel 201, the release code input screen to prompt an input of the release code. Then, the processing goes to step S20.

In step S20, the control device 204 determines whether the release code is input by the operating person and operation for ending the input is performed. In a case where affirmative determination is made in step S20, the processing goes to step S30.

In step S30, the control device 204 records, as operating person determination information, the release code input on the release code input screen or information, which indicates that the release code is not input, into the memory. Then, the processing goes to step S40.

In step S40, the control device 204 displays, on the touch panel 201, the emergent state checking screen to check the emergent state of the user. As described above, on the emergent state checking screen, a question to check whether the user responds to a call from the operating person or a question to check whether the user is breathing is displayed for the operating person and an input of an answer from the operating person is received.

Then, the processing goes to step S50 and the control device 204 determines whether the answer related to the emergent state of the user is received from the operating person with respect to the question displayed on the emergent state checking screen. In a case where affirmative determination is made in step 350, the processing goes to step S60.

In step S60, the control device 204 specifies the emergent state of the user based on contents of the answer from the operating person and records information indicating the specified result into the memory. Then, the processing goes to step S70.

In step S70, the control device 204 transmits the user ID and the operating person determination information of the user which are recorded in the memory to the emergency medical information providing apparatus 300. Then, the processing goes to step S80.

In step S80, the control device 204 determines whether the above-described information for transmission is received from the emergency medical information providing apparatus 300. In a case where affirmative determination is made in step S80, the processing goes to step S90.

In step S90, the control device 204 reads, from the memory, the information indicating the specified result of the emergent state of the user which information is recorded in step S60. Then, based on the read information, determination of the emergent state of the user, that is, determination whether the user responds to a call from the operating person and whether the user is breathing is made. Then, the processing goes to step S100.

In step S100, as a result of the determination in step S90, the control device 204 determines whether there are both of the response of the user and the breathing of the user. In a case where affirmative determination is made in step S100, the processing goes to step S110. On the other hand, in a case where negative determination is made in step S100, the processing goes to step S120.

In step S110, the control device 204 preferentially displays, on the touch panel 201, the treatment contents information included in the information for transmission and gives notification to the operating person. Here, as described above, the control device 204 first displays, on the touch panel 201, the treatment contents information display screen which displays the treatment contents information. Then, when operation for switching to a next screen is performed by the operating person, the control device 204 displays the user-related information display screen which displays the user attribute information, the dosing information, and the clinical history information. When the operation for switching to a next screen is further performed by the operating person, the control device 204 displays the emergency transfer destination information display screen which displays the emergency transfer destination information. Then, the processing goes to step S130.

Also, in step S120, the control device 204 preferentially displays the emergency transfer destination information included in the information for transmission. Here, as described above, the control device 204 first displays, on the touch panel 201, the emergency transfer destination information display screen which displays the emergency transfer destination information. Then, when operation for switching to a next screen is performed by the operating person, the control device 204 displays the treatment contents display screen which displays the treatment contents information. When the operation for switching to a next screen is further performed by the operating person, the control device 204 displays the user-related information display screen which displays the user attribute information, the dosing information, and the clinical history information. Then, the processing goes to step S130.

In step S130, when the call button displayed on the emergency transfer destination information display screen is touched by the operating person, the control device 204 determines whether the instruction for calling the emergency transfer destination is received from the operating person. In a case where negative determination is made in step 3130, the processing is ended. On the other hand, in a case where positive determination is made in step S130, the processing goes to step S140.

In step S140, based on the emergency transfer destination information, the control device 204 specifies a telephone number of a hospital of the emergency transfer destination. Then, by activating the call function included in the emergency response apparatus 200 and by making a call with the specified telephone number as a destination, the control device 204 makes a call to the hospital registered as the emergency transfer destination. Then, the processing is ended.

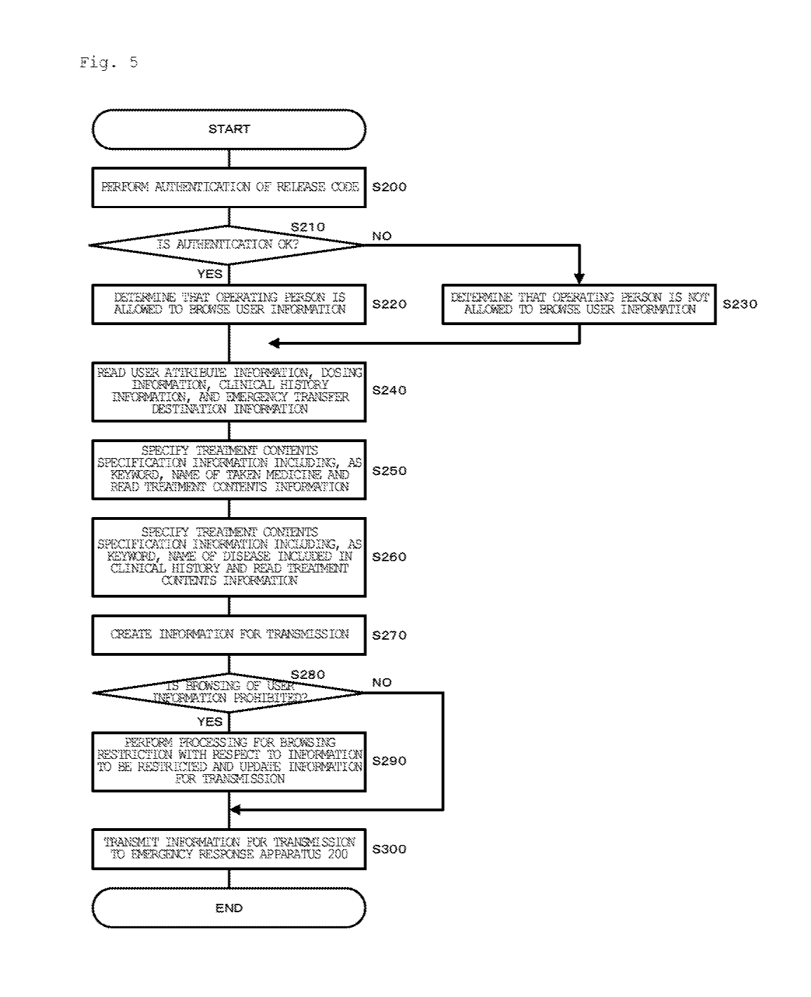

FIG. 5 is a flowchart illustrating a flow of processing executed in the emergency medical information providing apparatus 300 in the present embodiment. The processing illustrated in FIG. 5 is executed by the control device 303 as a program activated when the information transmitted in step S70 in FIG. 4 is received from the emergency response apparatus 200.

In step S200, by determining whether what matches the release code received as the operating person determination information is in the release code recorded in the recording device 304, the control device 303 performs authentication of the release code. Then, the processing goes to step S210.

In step S210, the control device 303 determines whether the authentication is OK as a result of the authentication in step S200, that is, whether what matches the release code received as the operating person determination information is in the release code recorded in the recording device 304.

In a case where affirmative determination is made in step S210, the processing goes to step S220 and the control device 303 determines that the operating person operating the emergency response apparatus 200 is a person allowed to browse the user information. Then, the processing goes to step S240.

On the other hand, in a case where negative determination is made in step S210, the processing goes to step S230 and the control device 303 determines that the operating person operating the emergency response apparatus 200 is a person not allowed to browse the user information. Then, the processing goes to step S240.

In step S240, based on the user ID received from the emergency response apparatus 200, the control device 303 reads the user attribute information, the dosing information, the clinical history information, and the emergency transfer destination information of the user from the recording device 304. Then, the processing goes to step S250.

In step S250, based on the dosing information of the user read in step S240, the control device 303 specifies a medicine taken by a user. The control device 303 specifies, in the treatment contents specification information recorded in the recording device 304, treatment contents specification information including, as the keyword of dosing, a name of a taken medicine specified based on the dosing information of the user. Then, the control device 303 reads, from the recording device 304, processing contents information included in the specified treatment contents specification information. Then, the processing goes to step S260.

In step S260, based on the clinical history information of the user read in step S240, the control device 303 specifies a clinical history of the user. The control device 303 specifies, in the treatment contents specification information recorded in the recording device 304, treatment contents specification information including, as the keyword of a clinical history, a name of a disease the user used to have which is specified based on the clinical history information of the user. Then, the control device 303 reads, from the recording device 304, processing contents information included in the specified treatment contents specification information. Then, the processing goes to step S270.

In step S270, the control device 303 creates information for transmission by associating the user attribute information, the dosing information, the clinical history information, the emergency transfer destination information, and the treatment contents information read from the recording device 304 with each other. Then, the processing goes to step S280.

In step S280, the control device 303 determines whether it is determined in step S230 that the operating person operating the emergency response apparatus 200 is a person not allowed to browse the user information. In a case where negative determination is made in step S280, the processing goes to step S300 described later. On the other hand, in a case where affirmative determination is made in step S280, the processing goes to step S290.

In step S290, the control device 303 performs processing, which is to restrict the browsing, with respect to previously-set information to be restricted in information included in the information for transmission created in step S270 and updates the information for transmission. Then, the processing goes to step S300.

In step S300, the control device 303 transmits the information for transmission to the emergency response apparatus 200. Then, the processing is ended.

According to the above-described first embodiment, the following function effects can be acquired.

(1) In the emergency response apparatus 200, the control device 204 transmits a user ID for specification of a user to the emergency medical information providing apparatus 300, receives, from the emergency medical information providing apparatus 300, treatment contents information indicating treatment contents given to the user, and notifies the treatment contents, which is specified based on the received treatment contents information, to an operating person. Also, in the emergency medical information providing apparatus 300, the control device 303 receives the user ID from the emergency response apparatus 200, refers to the treatment contents specification information for specification of treatment contents for each symptom recorded in the recording device 304, specifies treatment contents information indicating treatment contents to be given to the user specified based on the received user ID, and transmits the specified treatment contents information to the emergency response apparatus 200. Accordingly, even when the user is not able to communicate due to sudden illness or the like, the operating person can understand the treatment contents and can give first aid to the user.

(2) In the recording device 304 of the emergency medical information providing apparatus 300, a user ID and user information, which are associated with each other, are recorded. The control device 303 reads user information associated with a received user ID and transmits the user information to the emergency response apparatus 200. Then, in the emergency response apparatus 200, the control device 204 notifies the user information received from the emergency medical information providing apparatus 300 to an operating person. Accordingly, the operating person can understand information related to a user such as user attribute information, dosing information, clinical history information, and emergency transfer destination information included in the user information.

(3) Based on the dosing information associated with a user ID, the control device 303 specifies a name of a medicine taken by a user and specifies treatment contents specification information including the specified name of a medicine as a keyword. Accordingly, it is possible to estimate a symptom which the user might develop according to the medicine taken by the user and to notify treatment contents corresponding to the symptom to the operating person. As a result, a treatment preferable to a user who needs first aid becomes more likely to be given by the operating person.

(4) Based on clinical history information associated with a user ID, the control device 303 specifies a name of a disease, which a user currently has or used to have, and specifies treatment contents specification information including the specified name of a disease as a keyword. Accordingly, it is possible to estimate a symptom which the user might develop according to a clinical history of the user and to notify treatment contents corresponding to the symptom to the operating person. As a result, a treatment preferable to a user who needs first aid becomes more likely to be given by the operating person.

(5) Based on operation by an operating person, the control device 204 specifies an emergent state of a user and determines, based on the specified result, which of notification of emergency transfer destination information and notification of treatment contents information which are included in user information is to be preferentially given. More specifically, when determining that at least one of a response of the user and breathing of the user is not performed, the control device 204 determines to give the notification of the emergency transfer destination information prior to the notification of the treatment contents information. Also, when determining that there are both of the response of the user and the breathing of the user, the control device 204 determines to give the notification of the treatment contents information prior to the notification of the emergency transfer destination information. Accordingly, when it is preferred that a transfer to an emergency transfer destination is preferentially performed, such as in a case where there is no response of the user or a case where the user is not breathing, it is possible to preferentially notify the emergency transfer destination to the operating person by preferentially displaying the emergency transfer destination information. Also, when it is preferred that first aid at the place is performed prior to a transfer to the emergency transfer destination, such as in a case where there are both of the response of the user and the breathing of the user, it is possible to preferentially notify, to the operating person, treatment contents to be given to the user by preferentially displaying the treatment contents information.

(6) In the emergency response apparatus 200, the control device 204 receives, from an operating person, an input of a release code to release browsing restriction of user information and transmits the input release code to the emergency medical information providing apparatus 300. Also, in the emergency medical information providing apparatus 300, the control device 303 performs authentication whether the release code received from the emergency response apparatus 200 is a valid release code. Then, when determining that the release code is not the valid release code, the control device 303 performs editing of user information, the editing being for browsing restriction of at least a previously-set part of the user information, that is, information to be restricted. Accordingly, it is possible to prohibit the person, who is not allowed to browse the user information, to browse the previously-set information to be restricted and to protect personal information of the user.

(7) In a case of notifying emergency transfer destination information to an operating person, the control device 204 displays, on an emergency transfer destination information display screen displayed on the touch panel 201, a call button to receive, from the operating person, an instruction for calling an emergency transfer destination. Then, when detecting that the call button is touched by the operating person, the control device 204 specifies a telephone number of a hospital of the emergency transfer destination based on the emergency transfer destination information, activates a call function included in the emergency response apparatus 200, and makes a call with the telephone number as a destination. Accordingly, the operating person can make a call to the hospital of the emergency transfer destination with easy operation without inputting the telephone number. Also, even when a user is in an emergent state and the operating person is in panic, it is possible to prevent an error in inputting the telephone number and to securely make a call to the hospital of the emergency transfer destination.

### Second Embodiment

In the above-described first embodiment, a method of specifying treatment contents to be given to a user based on dosing information and clinical history information which are associated with a user ID and notifying the treatment contents to an operating person has been described. In the second embodiment, a case where a user accidentally ingests a foreign object is assumed and a method of notifying a method of removing a foreign object to an operating person, specifying treatment contents to be given to the user based on dosing information and clinical history information associated with a user ID, and notifying the treatment contents to the operating person will be described. Also, in the second embodiment, when the user is not breathing and does not respond, a breast bone pressing method is notified to the operating person. Moreover, when the user needs artificial respiration, an artificial respiration method is notified to the operating person in addition to the breast bone pressing method. Note that in the second embodiment, FIG. 1 to FIG. 3 and FIG. 5 described in the first embodiment are similar to what is described in the first embodiment, and thus, a description thereof is omitted.

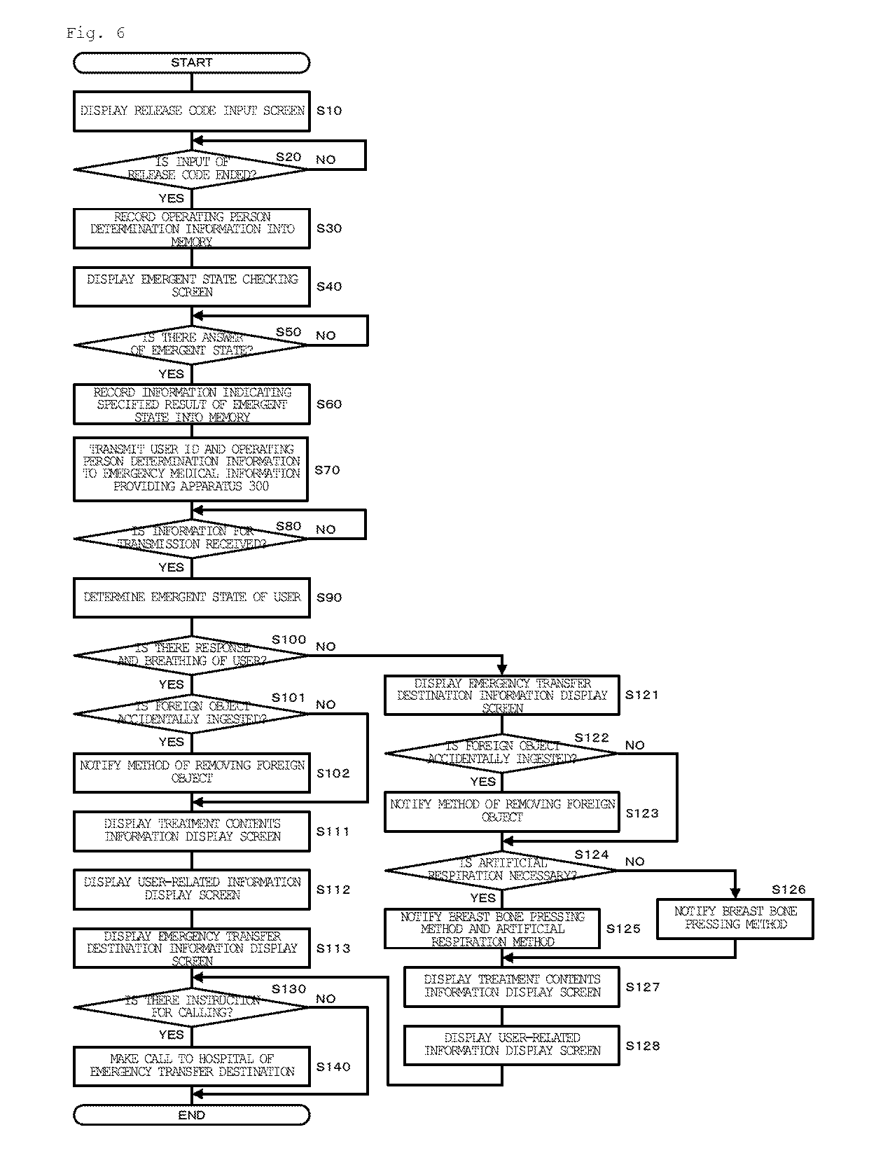

FIG. 6 is a flowchart illustrating a flow of processing executed in an emergency response apparatus 200 in the second embodiment. Similarly to the processing in FIG. 4 in the first embodiment, processing illustrated in FIG. 6 is executed by a control device 204 as a program activated when an emergency medical service application is instructed by an operating person while the emergency response apparatus 200 is locked. Note that in the flowchart illustrated in FIG. 6, the same step number is assigned to processing identical with that in the flowchart illustrated in FIG. 4 and a description thereof is omitted. In the following, a point different from FIG. 4 will be mainly described.

In a case where affirmative determination is made in step S100, the processing goes to step S101 and the control device 204 determines whether a user accidentally ingests a foreign object. For example, the control device 204 displays, on a touch panel 201, a message to ask an operating person whether the user accidentally ingests a foreign object. When the operating person performs operation indicating that the user accidentally ingests a foreign object, affirmative determination is made in step S101. For example, the control device 204 displays a checking message such as “Is it accidental ingestion of a foreign object?” and buttons of “Yes” and “No” on the touch panel 201. When detecting that the “Yes” button is touched by the operating person, the control device 204 makes affirmative determination in step S101. On the other hand, when it is detected that the “No” button is touched by the operating person, negative determination is made in step S101.

When the negative determination is made in step S101, the processing goes to step S111 described later. On the other hand, when the affirmative determination is made in step S101, the processing goes to step S102. In step S102, the control device 204 reads and reproduces a moving image, which is previously recorded in a memory and which is for describing a method of removing an accidentally-ingested foreign object, and displays the moving image on the touch panel 201. Accordingly, the operating person can understand the method of removing the foreign object accidentally ingested by the user. Then, the processing goes to step S111.

From step S111 to step S113, similarly to step S110 in FIG. 4, the control device 204 transitions a screen in such a manner that treatment contents information included in information for transmission is preferentially notified to the operating person. That is, in step S111, the control device 204 displays, on the touch panel 201, a treatment contents information display screen which displays the treatment contents information. Then, the processing goes to step S112 and the control device 204 displays a user-related information display screen which displays user attribute information, dosing information, and clinical history information. Then, the processing goes to step S113 and the control device 204 displays an emergency transfer destination information display screen which displays emergency transfer destination information. Then, the processing goes to step S130. Accordingly, similarly to the first embodiment, when there are both of a response of the user and breathing of the user, the treatment contents information included in the information for transmission is preferentially notified to the operating person.

On the other hand, in a case where negative determination is made in step S100, the processing goes to step S121. In step S121, the control device 204 displays the emergency transfer destination information display screen which displays the emergency transfer destination information. Then, the processing goes to step S122.

In step S122, the control device 204 determines whether the user accidentally ingests a foreign object. Here, a method of determination is similar to that in step S101 described above, and thus, a description thereof is omitted. In a case where negative determination is made in step S122, the processing goes to step S124 describe later. On the other hand, in a case where affirmative determination is made in step S122, the processing goes to step S123.

In step S123, similarly to step S102 described above, the control device 204 reads and reproduces the moving image, which is previously recorded in the memory and which is for describing the method of removing an accidentally-ingested foreign object, and displays the moving image on the touch panel 201. Accordingly, the operating person can understand the method of removing a foreign object accidentally ingested by the user. Then, the processing goes to step S124.

In step S124, as a response in a case where the user is not breathing, the control device 204 determines whether artificial respiration is necessary in addition to the breast bone pressing. In the present embodiment, a case of determining that the artificial respiration is necessary in addition to the breast bone pressing when the user is a child including a toddler or a juvenile will be described. In this case, the control device 204 records a height of the user into the memory when user information described in the first embodiment is input. When the height recorded in the memory is shorter than a predetermined height such as 160 cm, it is determined that the artificial respiration is also necessary for the user. Alternatively, a birth date of the user may be recorded into the memory when user information is input. When an age of the user specified based on the birth date recorded in the memory is smaller than a predetermined age such as 10 years old, it may be determined that the artificial respiration is also necessary for the user. Alternatively, the operating person may input whether the user is a child by operating the touch panel 201 and the control device 204 may determine that the artificial respiration is also necessary for the user based on contents input by the operating person.

When affirmative determination is made in step S124, the processing goes to step S125. The control device 204 reads and reproduces a moving image, which is previously recorded in the memory and which is for describing a breast bone pressing method and an artificial respiration method to be performed on the user, and displays the moving image on the touch panel 201. Note that when the breast bone pressing method or the artificial respiration method varies depending on an age or the like of a subject, a moving image of a breast bone pressing method and an artificial respiration method for a child is reproduced here. Accordingly, when the user is a child, a proper handling method for the user can be notified to the operating person in consideration of the determination that the artificial respiration is preferably performed in addition to the breast bone pressing. Also, the operating person can understand the breast bone pressing method and the artificial respiration method to be performed with respect to the user and can respond in a proper manner suitable for the user. Then, the processing goes to step S127 described later.

On the other hand, in a case where negative determination is made in step S124, the processing goes to step S126. In step S126, the control device 204 reads and reproduces a moving image, which is previously recorded in the memory and which is for describing a breast bone pressing method to be performed generally, and displays the moving image on the touch panel 201. The breast bone pressing method to be performed generally is, for example, a breast bone pressing method on the assumption of a general adult. Accordingly, the operating person can understand the breast bone pressing method to be performed with respect to the user. Then, the processing goes to step S127.

In step S127, the control device 204 displays, on the touch panel 201, a treatment contents information display screen which displays treatment contents information. Then, the processing goes to step S128 and the control device 204 displays a user-related information display screen which displays user attribute information, dosing information, and clinical history information. Then, the processing goes to step S130.

Accordingly, also in the second embodiment, the emergency transfer destination information included in the information for transmission is preferentially notified to the operating person when it is determined that at least one of a response of the user and breathing of the user is not performed.

According to the above-described second embodiment, the following function effects can be acquired in addition to the function effects by the first embodiment.

(1) In the emergency response apparatus 200, when determining that a user accidentally ingests a foreign object, the control device 204 notifies a method of removing a foreign object to an operating person. Accordingly, the operating person can understand the method of removing a foreign object accidentally ingested by the user.

(2) In the emergency response apparatus 200, when determining that at least one of a response of a user and breathing of the user is not performed, the control device 204 notifies, to an operating person, a breast bone pressing method to be performed with respect to the user. Accordingly, the operating person can understand the breast bone pressing method to be performed with respect to the user.

(3) In the emergency response apparatus 200, when determining that artificial respiration is necessary for a user in a case where at least one of a response of the user and breathing of the user is not performed, the control device 204 notifies, to an operating person, an artificial respiration method to be performed with respect to the user along with a breast bone pressing method. Accordingly, the operating person can understand the breast bone pressing method and the artificial respiration method to be performed with respect to the user and can make a proper response suitable for the user.

(4) In the emergency response apparatus 200, when a user is a child, the control device 204 determines that artificial respiration is necessary in addition to breast bone pressing. Accordingly, when the user is a child, a proper handling method which reflects an actual condition that the artificial respiration is preferably performed in addition to the breast bone pressing can be notified to the operating person.

### Modification

Note that the emergency medical service system 100 in each of the above-described embodiments can be modified in a manner described in the following.

(1) In the above-described first and second embodiments, dosing information and clinical history information are included in user information and a keyword of dosing and a keyword of clinical history are included in treatment contents specification information. Then, the control device 303 specifies dosing information and clinical history information associated with a user ID and specifies treatment contents specification information including a specified name of a medicine or a specified name of a disease as a keyword. Treatment contents information included in the specified treatment contents specification information is included in information for transmission. However, the control device 303 may specify treatment contents specification information based on one of the dosing information and the clinical history information.

(2) In the above-described first and second embodiment, the control device 303 performs authentication whether a received release code is a valid release code by determining whether there is what matches the release code, which is received as operating person determination information from the emergency response apparatus 200, in a release code recorded in the recording device 304. Then, when the authentication is OK, the control device 303 determines that an operating person operating the emergency response apparatus 200 is a person allowed to browse user information. In this case, in order to prevent unauthorized use of the release code, with which it is determined that the authentication is OK, by a different operating person, the control device 303 may invalidate the release code with which it is determined that the authentication is OK. In this case, the control device 303 may record the time and date, at which the release code is received, as the time and date at which the release code is used and may record a user ID which is received at the same time as a user ID to which the release code is used. Accordingly, it is possible to invalidate the release code which is used once and to prevent unauthorized use of the release code. Also, by recording the time and date at which the release code is used or a user ID to which the release code is used, it is possible to manage a history of usage of the release code.

(3) In the above-described first and second embodiments, when determining that at least one of a response of a user and breathing of the user is not performed, the control device 204 determines to give notification of emergency transfer destination information prior to notification of treatment contents information. Also, when it is determined that there are both of the response of the user and the breathing of the user, it is determined that the notification of the treatment contents information is given prior to the notification of the emergency transfer destination information. Here, when determining to give the notification of the emergency transfer destination information prior to the notification of the treatment contents information, the control device 204 first displays an emergency transfer destination information display screen on the touch panel 201. Then, according to operation for switching to a next screen performed by an operating person, the control device 204 transitions screens in an order of a treatment contents display screen and a user-related information display screen. However, an order of displayed screens is not limited to the above as long as the notification of the emergency transfer destination information is given prior to that of the treatment contents information. That is, the above-described screen transmission example is not a limitation as long as the notification of the user information is given prior to the notification of the treatment contents information and first priority is given to the notification of the emergency transfer destination information in the user information.

Also, when determining to give the notification of the treatment contents information prior to the notification of the emergency transfer destination information, the control device 204 first displays a treatment contents information display screen on the touch panel 201. Then, according to operation for switching to a next screen performed by the operating person, screens are transitioned in an order of the user-related information display screen and the emergency transfer destination information display screen. However, an order of displayed screens is not limited to the above as long as the notification of the treatment contents information is given prior to the notification of the emergency transfer destination information. That is, the above-described screen transition example is not a limitation as long as screens are transitioned in such a manner that the notification of the treatment contents information is given prior to the notification of the user information.

(4) In the above-described first and second embodiments, an example in which a general information terminal such as a smartphone or a tablet terminal is used as the emergency response apparatus 200 has been described. However, a special terminal to communicate with the emergency medical information providing apparatus 300 may be used instead of the general information terminal.

(5) In the above-described second embodiment, in step S124 in FIG. 6, the control device 204 determines that artificial respiration is necessary in addition to breast bone pressing when a user is a child including a toddler or a juvenile. Then, an example in the following has been described. That is, in a case where affirmative determination is made in step S124, the processing goes to step S125 and the control device 204 reads and reproduces a moving image, which is previously recorded in a memory and which is for describing a breast bone pressing method and an artificial respiration method to be performed with respect to the user, and displays the moving image on the touch panel 201. However, in a case where the breast bone pressing method or the artificial respiration method varies depending to an age of the user, the control device 204 may perform processing in consideration of the age of the user. For example, when the breast bone pressing method or the artificial respiration method varies between a case where the user is smaller than one year old and a case where the user is older than one year old, the processing may be divaricated according to an age of the user. In this case, when the user is smaller than one year old, a moving image for describing a breast bone pressing method or an artificial respiration method for a toddler smaller than one year old is reproduced. Also, when the user is older than one year old, a moving image for describing a breast bone pressing method or an artificial respiration method for a child older than one year old is reproduced. Accordingly, it is possible to notify, to an operating person, a proper breast bone pressing method or artificial respiration method corresponding to an age of the user.

(6) In the above-described second embodiment, an example of notifying, to an operating person, a method of removing an accidentally-ingested foreign object, a breast bone pressing method, and an artificial respiration method by reproducing a moving image previously recorded in a memory has been described. However, a method of giving notification to the operating person is not limited to the above. For example, by recording, into the memory, a text or an image for description of the method of removing an accidentally-ingested foreign object, the breast bone pressing method, and the artificial respiration method and by displaying the text or the image on the touch panel 201, notification may be given to the operating person. Also, data of the moving image, the text, and the image may be recorded in the recording device 304 of the emergency medical information providing apparatus 300 and the control device 204 may acquire the data from the emergency medical information providing apparatus 300 and may display the data on the touch panel 201.

Note that the present invention is not limited to a configuration in each of the above-described embodiments as long as a characteristic function of the present invention is not impaired. Also, the above-described embodiments and a plurality of modifications may be combined.

Disclosure of the following priority basic application is hereby incorporated by reference. Japanese Patent Application No. 2013-192559 (filed Sep. 18, 2013).

1. An emergency medical service system comprising:
an emergency response apparatus operated by an operating person to give first aid to a user when the user needs the first aid; and
an emergency medical information providing apparatus connected to the emergency response apparatus through a communication line,
wherein the emergency response apparatus includes
a user specification information transmission unit configured to transmit information for specification of the user to the emergency medical information providing apparatus,
a treatment contents information reception unit configured to receive, from the emergency medical information providing apparatus, treatment contents information indicating treatment contents given to the user, and
a treatment contents notification unit configured to notify, to the operating person, the treatment contents specified based on the treatment contents information received by the treatment contents information reception unit,
the emergency medical information providing apparatus includes
a user specification information reception unit configured to receive the information for specification of the user from the emergency response apparatus,
a user information reading unit configured to read, from a recording device, user information associated with the information for specification of the user received by the user specification information reception unit,
a unit of specifying a name of a medicine configured to specify a name of a medicine taken by the user based on dosing information indicating information related to the medicine, which is taken by the user, in a case where the dosing information is included in the user information read by the user information reading unit,
a dosing information determination unit configured to determine, with reference to treatment contents specification information which includes a name of a medicine and treatment contents information indicating treatment contents determined by the name of a medicine and which is recorded in the recording device, whether treatment contents specification information including the name of a medicine specified by the unit of specifying a name of a medicine is recorded in the treatment contents specification information,
a unit of specifying a name of a disease configured to specify a name of a disease the user has based on clinical history information indicating a clinical history of the user in a case where the clinical history information is included in the user information read by the user information reading unit,
a clinical history information determination unit configured to determine, with reference to treatment contents specification information which includes a name of a disease and treatment contents information indicating treatment contents determined by the name of a disease and which is recorded in the recording device, whether treatment contents specification information including the name of a disease specified by the unit of specifying a name of a disease is recorded in the treatment contents specification information,
a treatment contents information specification unit configured to specify treatment contents information for transmission which information is to be transmitted to the emergency response apparatus based only on a result of the determination by the dosing information determination unit and a result of the determination by the clinical history information determination unit, and
a treatment contents information transmission unit configured to transmit, to the emergency response apparatus, the treatment contents information for transmission, which is specified by the treatment contents information specification unit, as treatment contents information indicating treatment contents given to the user, and
when it is determined by the dosing information determination unit that the treatment contents specification information including the name of a medicine specified by the unit of specifying a name of a medicine is recorded, the treatment contents information specification unit specifies, as the treatment contents information for transmission, treatment contents information included in the treatment contents specification information and when it is determined by the clinical history information determination unit that the treatment contents specification information including the name of a disease specified by the unit of specifying a name of a disease is recorded, the treatment contents information specification unit specifies, as the treatment contents information for transmission, treatment contents information included in the treatment contents specification information.

2. The emergency medical service system according to claim 1, wherein the user information includes user attribute information indicating an attribute of the user, the dosing information, the clinical history information, and emergency transfer destination information indicating an emergency transfer destination of the user,
the emergency medical information providing apparatus further includes a user information transmission unit configured to transmit the user information read by the user information reading unit to the emergency response apparatus, and
the emergency response apparatus further includes a user information reception unit configured to receive the user information from the emergency medical information providing apparatus, and a user information notification unit configured to notify the user information received by the user information reception unit to the operating person.

3. The emergency medical service system according to claim 2, wherein the emergency response apparatus further includes an emergent state specification unit configured to specify an emergent state of the user based on operation performed by the operating person, and a prior notification determination unit configured to determine which of a notification of the user information by the user information notification unit and a notification of the treatment contents by the treatment contents notification unit is to be given preferentially based on the emergent state of the user specified by the emergent state specification unit.

4. The emergency medical service system according to claim 3, wherein the prior notification determination unit is configured to determine whether there are a response of the user to a call from the operating person and breathing of the user based on the emergent state of the user specified by the emergent state specification unit,
when it is determined that at least one of the response of the user and the breathing of the user is not performed, it is determined that the notification of the user information by the user information notification unit is given prior to the notification of the treatment contents by the treatment contents notification unit, and
when it is determined that there are both of the response of the user and the breathing of the user, it is determined that the notification of the treatment contents by the treatment contents notification unit is given prior to the notification of the user information by the user information notification unit.

5. The emergency medical service system according to claim 4, wherein when determining that at least one of the response of the user and the breathing of the user is not performed based on the emergent state of the user specified by the emergent state specification unit, the user information notification unit preferentially notifies the emergency transfer destination information in the user information.

6. The emergency medical service system according to claim 4, wherein the emergency response apparatus further includes a breast bone pressing method notification unit configured to notify, to the operating person, a method of breast bone pressing performed with respect to the user when it is determined that at least one of the response of the user and the breathing of the user is not performed based on the emergent state of the user specified by the emergent state specification unit.

7. The emergency medical service system according to claim 6, wherein the emergency response apparatus further includes an artificial respiration method notification unit to notify, to the operating person, a method of artificial respiration performed with respect to the user along with the method of breast bone pressing when it is determined that at least one of the response of the user and the breathing of the user is not performed based on the emergent state of the user specified by the emergent state specification unit and when it is determined that the artificial respiration is necessary for the user.

8. The emergency medical service system according to claim 7, wherein the artificial respiration method notification unit determines that the artificial respiration is necessary for the user when the user is a child.

9. The emergency medical service system according to claim 2, wherein the emergency response apparatus further includes a unit of receiving an input of a release code configured to receive, from the operating person, an input of a release code to release browsing restriction of the user information, and a release code transmission unit configured to transmit the release code, an input of which is received by the unit of receiving an input of a release code, to the emergency medical information providing apparatus, and
the emergency medical information providing apparatus further includes a release code reception unit configured to receive the release code from the emergency response apparatus, an authentication unit configured to perform authentication whether the release code received by the release code reception unit is a valid release code, and a user information editing unit configured to perform editing for restriction of browsing, by the operating person, of at least a previously-set part of the user information specified by the user information specification unit when it is determined by the authentication unit that the release code is not the valid release code.

10. The emergency medical service system according to claim 2, wherein in a case of displaying the emergency transfer destination information included in the user information, the user information notification unit displays, on a display device, a call button to receive an instruction for calling an emergency transfer destination from the operating person.

11. The emergency medical service system according to claim 10, wherein the emergency response apparatus further includes a calling unit configured to specify a telephone number of a hospital specified as the emergency transfer destination based on the emergency transfer destination information and to make a call to the telephone number when operation on the call button performed by the operating person is detected.

12. The emergency medical service system according to claim 1, wherein the emergency response apparatus further includes an accidental ingestion determination unit to determine whether the user accidentally ingests a foreign object, and a unit of notifying a method of removing a foreign object configured to notify a method of removing a foreign object to the operating person when it is determined by the accidental ingestion determination unit that the user accidentally ingests the foreign object.

13. The emergency response apparatus according to claim 1.

14. The emergency medical information providing apparatus according to claim 1.
